(19) United States
(12) Patent Application Publication
(10) Pub. No.: US 2011/0173045 A1
(43) Pub. Date: Jul. 14, 2011

(54) System and methods for improving hazardous incident prevention, mitigation and response

(76) Inventor: Andrew Martin Jaine, Incline Village, NV (US)

(21) Appl. No.: 12/686,157

(22) Filed: Jan. 12, 2010

Related U.S. Application Data
(60) Provisional application No. 61/144,428, filed on Jan. 13, 2009.

(51) Int. Cl. G06Q 10/00

(52) U.S. Cl. 705/7.28

(57) ABSTRACT

The invention comprises a system, method, and computer program product that enables any stakeholder that has responsibility for responding to hazardous incidents with a systematic process whereby they can optimize and continuously improve their abilities to reduce the harm caused by such incidents. This process is tailored to the stakeholder's individual characteristics and practices but also facilitates comparability between stakeholders and provides methods to evaluate the potential consequences of each attack form, prioritize investments in mitigative activities and to evaluate the efficacy of such investments.

### CROSS REFERENCE TO RELATED APPLICATIONS

This application claims the benefit under 35 U.S.C. §119(e) of earlier filed application with EFS ID. 4607562 and application No. 61/144,428 titled “SYSTEM AND METHOD FOR BENCHMARKING THE LEVEL OF READINESS OF AN ENTITY TO RESPOND TO INCIDENTS OF A POTENTIALLY ADVERSE NATURE, TO REMEDIATE SUB-OPTIMAL LEVELS OF PREPAREDNESS AND FOR CONTINUOUS IMPROVEMENT IN THE CAPABILITIES TO RESPOND TO SUCH INCIDENTS” filed Jan. 13, 2009. The foregoing is incorporated by reference in its entirety.

### GOVERNMENT INTEREST

The invention described herein may be licensed and used by or for the U.S. Government.

### BACKGROUND

1. Field of the Invention

The present invention relates generally to class 705, business practice and management, and more particularly to hazardous risk mitigation systems.

2. Description of the Related Art

Over the first decade of this new millennium our nation has been forced to change the way in we look at domestic preparedness. In the 20th century we were primarily concerned with protecting hard assets—buildings, ship-yards, military bases, etc. Consequently preparedness programs were largely grant programs administered by the Department of Justice that concentrated on hardening those physical assets. In this decade we have experienced an enormous range of different hazardous incidents. Some have had a huge, drawn out national impact (like 9/11 in 2001; the Hurricane Katrina disaster in 2005, the foodborne melamine outbreak in 2008 and the peanut butter outbreak in 2009) but many more have been short and local, like the many hundreds or thousands of small incidents that occur every year but which are over so fast that they go unreported.

Our food supply is particularly vulnerable to such hazardous incidents. Much of our food supply is produced on production lines that have relatively constant output. If some sort of systemic process contaminates that production line the profile of illnesses that result can be relatively constant over a long period. Conversely if the incident is a one time contamination of a single batch of product then the illnesses typically increase very rapidly but then also die off rapidly. There are an almost infinite number of variations of such profiles.

But the current reality is that such unintentional incidents may not be the greatest hazards that we face, as there are people and groups in the world who have the both the desire and capability to inflict great harm on us. Our open society includes a wide array of critical infrastructure and key resources that are potential terrorist targets, most of which are owned and operated by the private sector and state or local governments. Some of these critical infrastructures and key resources are physical, but many are complex systems, like the food system, the agriculture system, the communications system, etc.

Effective defense of these complex systems requires a different approach from defense of hard assets, and our national policies have attempted to address these changes by transitioning from being asset-based to being system-based. In 2004 the Homeland Security Presidential Directive 7 was released which focused on the great potential risk of terrorist attacks, and since then our national preparedness plans have morphed from the Federal Response Plan through the National Response Plan and the National Incident Management System and now the National Response Framework under which the cornerstones of domestic preparedness have become prevention, protection, response and recovery.

These plans reflect a dramatic increase the nature and complexity of defense. We cannot effectively defend complex systems with fences and guns; we must instead strengthen and train the human resources in our agencies and our companies. And we cannot just concentrate on objects that are physically large, because physically small things, like “suitcase” nuclear bombs, could cause catastrophe. So it is necessary that the stakeholders that are responsible for defense against potential hazards have the capacity and capability to prevent the occurrence of such incidents and also to respond with an appropriate, effective defense when such incidents do occur. So stakeholders must prepare, train, exercise, develop abilities and employ strategies that are tailored a very wide range of scenarios.

But the capabilities required to effectively protect and respond often vary greatly with changes in the characteristics and stage of the incident. Protection against incidents must occur prior to them commencing and requires “hardening” of the incident targets. This sometimes involves the building of fences and walls around physical assets, but more frequently involves training personnel on prevention techniques. Effective response to mitigate emerging incidents requires many different skill sets. During the early stages of an incident detective-like skills are required to detect that the incident exists, then to identify what is causing it. Later in the incident medical skills may be needed to handle the illnesses, etc. If an incident is long and drawn out then characteristics like rotating staff to prevent exhaustion and replenishing supplies are of great importance, but in short, sharp incidents speed and accuracy are more important. In all types of incident small delays or mistakes in handing-off responsibility between stakeholders can cause major changes in the impacts, and so advance preparation and training of responders is critical. And the different skills required are often the responsibility of a myriad of different types of stakeholder, often in different agencies or companies and sometimes with conflicting priorities.

During the same period when the dramatic changes in the nature of preparedness described above have been occurring there has been a significant downturn in the economy. Funding to the agencies of federal and state governments and resources in the private sector are reduced, and stakeholders are seldom able to address the entire spectrum of demands required for optimal defense of the systems for which they are responsible, so choices have to be made. To address this the National Infrastructure Protection Plan requires that each state systematically assesses its various risks, then prioritizes these risks, develops and implements comprehensive Risk Management Plans to address those of the highest priority and then demonstrates the effectiveness of those plans. But while the federally mandated plans like the National Infrastructure Protection Plan require stakeholders to prioritize the risks that they face and develop and validate effective plans for the mitigation of those risks they do not provide systems or methods to accomplish these tasks, and developing such solutions is left up to the individual stakeholders. These stakeholders are usually skilled in executing the particular tasks of incident mitigation, but frequently are unskilled in executing the broader requirements of planning, assessing and prioritizing the abilities required to optimize such mitigation, and frequently end up “reinventing the wheel” in different forms. This results in an unprecedented need for the development of effective systems for improving hazardous incident prevention, mitigation and response to enable both public and private sectors to grapple with the increasing complexities of defending these critical, complex systems.

### BRIEF SUMMARY OF THE INVENTION

The current invention provides a system, methods and computer programs that will enable stakeholders who have responsibility to protect and defend complex systems assets against hazardous risks to identify optimal approaches for such protection and defense and then plan, implement and validate the effectiveness of such approaches.

This hazardous risk mitigation system decomposes the activities required to protect and defend complex systems into sets of easily understood responsibilities; identifies the activities and capabilities required to effectively execute those responsibilities and provides computer systems and associated algorithms to prioritize those activities and abilities that are most influential in reducing the impacts of attacks on the system(s). It also provides a structured mechanism for identifying the available resources (public and/or private) that already possess the identified mitigative abilities or have the capacity for development of those abilities; provides a mechanism to focus the activities of each such stakeholder group on the specific areas for which they are responsible, and then iteratively quantifies the existing level of performance of such responsibilities; identifies those that are most in need of improvement; evaluates the success or failure of improvement activities, and re-prioritizes.

### BRIEF DESCRIPTION OF THE DRAWINGS

FIG. 1 illustrates a schematic diagram of one embodiment of the hazardous risk mitigation system of the present invention.

FIG. 2 illustrates a block diagram of one process used by the hazardous risk mitigation system to prioritize hazardous scenarios.

FIG. 3 illustrates an example of the key abilities that may be required for effective protection and response to one particular example of a hazardous incident.

FIG. 4 illustrates a block diagram of one embodiment of a risk assessment process that characterizes how the level of stakeholder performance of key incident mitigation activities affects the impact of the incident.

FIG. 5 illustrates a block diagram of one process used by the hazardous risk mitigation system to determine various aspects of the manner in which each mitigative ability required to protect a complex system or to respond to a hazardous incident involving such a system affects the aggregate impact of that incident on the system.

FIG. 6 illustrates an example of how changes in mitigative abilities affect the impact of an incident involving a complex system.

FIG. 7 illustrates a block diagram of one process used by the hazardous risk mitigation system to determine the level at which stakeholders in an incident can perform the various activities that are required for effective mitigation of that incident.

FIG. 8 illustrates a block diagram of one process whereby the information generated by the processes shown in FIGS. 2, 4, 5 and 7 are used to develop Risk Management Plans and live event response programs for stakeholders. Risk Management plans are used to develop and implement plans for remediating hazardous scenarios, to train and exercise responding personnel and to evaluate the effectiveness of the training and mitigative activities. The live incident response programs are used to guide the responding personnel on the activities that they should be performing at each stage of evolution of a live incident to mitigate the impacts of that incident.

FIG. 9 illustrates a block diagram of one process whereby the effectiveness of a Risk Management plan may be evaluated to provide information for the continuous refinement and improvement of risk management capabilities.

FIG. 10 illustrates one example of a form that may be used to facilitate the identification of the roles and areas of responsibility that stakeholders have for prevention and response to hazardous incidents.

FIG. 11 illustrates one example of an opening computer display screen that may be used in the computerized simulation of a hazardous incident.

FIG. 12 illustrates one example of a computer display screen that allows entry of the evaluations of levels of performance of mitigative activities that may be exhibited by stakeholders during the computerized simulation of a hazardous incident.

FIG. 13 illustrates one example of a computer screen display as it may appear during the early stages of a computerized simulation of an incident.

FIG. 14 illustrates one example of a legend of the various icons that may be displayed on a computer screen during a computerized simulation of an incident.

FIG. 15 illustrates one example of a computer screen display as it may appear at the end of the first simulated day of a computerized simulation of an incident.

FIG. 16 illustrates one example of a detail display of the information on the various impacts of a hazardous incident at a single location that may be displayed on a computer screen during a computerized simulation of an incident.

FIG. 17 illustrates one example of a computer screen display as it may appear when the map of the impacts of an incident is drilled down to show the details of a specific geographic location involved in the incident.

FIG. 18 illustrates one example of a display of a computerized simulation that summarizes the impact of the incident at various locations.

FIG. 19 illustrates one example of a computer screen display as it may appear at the end of a computerized simulation of an incident.

FIG. 20 illustrates one example of an area on a computer screen that may be used to enter and display data on the performance of certain aspects of mitigation of an incident.

FIG. 21 illustrates one example of an opening computer display screen that may be used in a secondary run of a computerized simulation of a hazardous incident that displays the effects on that incident that would result from mitigative intervention in the incident evolution.

FIG. 22 illustrates one example of a window that is displayed on a computer screen during a computerized simulation of an incident to inform the stakeholders in that incident of the identification of the incident

FIG. 23 illustrates one example of a window that is displayed on a computer screen during a computerized simulation of an incident to inform the stakeholders in that incident of an intervention being invoked to mitigate the effects of the incident

FIG. 24 illustrates one example of a window that is displayed on a computer screen during a computerized simulation of an incident to inform the stakeholders in that incident of the commencement of medical mitigations for patients who become ill as a result of the incident

FIG. 25 illustrates one example of a computer screen display that shows the hospitals that are located in the region of the incident and the detailed information on a selected hospital that may treat patients of the incident.

FIG. 26 illustrates one example of a computer screen display as it may appear at the end of a computerized simulation of an incident that was mitigated by stakeholder intervention.

FIG. 27 illustrates one example of a comparison of the impact of an incident that is unmitigated versus the impact of an incident that is mitigated to the level of performance demonstrated by the stakeholders.

FIG. 28 illustrates one example of an area on a computer screen that displays data on the target levels of performance of certain aspects of mitigation of an incident.

FIG. 29 illustrates one example of a comparison of the impact of an incident that is unmitigated versus the impact of an incident that is mitigated to the level of performance demonstrated by the stakeholders and versus the impact of an incident that is mitigated at an optimal level of mitigative performance.

### DETAILED DESCRIPTION OF THE INVENTION

For the purpose of this invention the term “scenario” is used to mean an outline or description of a potential incident whereby a specified type of target may be harmed by a specified form of hazardous incident. The terms “stakeholder” and “stakeholders” refers to the person or collection of people and organizations that are responsible for any of the activities required to effectively mitigate the impact of any such scenario. The term “Key Impact Metric” of a specific type of hazardous incident is used herein to mean the standard unit of measurement of a particular form of adverse impact of the incident that is considered by the stakeholders to be important in assessing the total impact of that incident.

Many different factors may affect the total impact on an incident, however not all of these factors can be changed by mitigative actions on the part of the stakeholders. The term “Key Mitigative Ability” is used herein to mean any ability related to a specific type of hazardous incident that stakeholders in such an incident must exhibit to achieve effective reduction of the level of any of the Key Impact Metrics of that incident and that may reasonably be performed by the stakeholders. If all stakeholders involved in an incident were to perform all the Key Mitigative Abilities for which they are responsible at the highest level possible then the adverse effects of the incident would be minimized to the greatest extent possible.

The present invention will be discussed with reference to a preferred embodiment of risk management programs for mitigating the effects of hazardous incidents of any type, including terrorist incidents (for example an intentional release of a toxic inhalation agent into the air, the detonation of an explosive device on an airplane, an intentional contamination of a cattle herd with a zoonotic disease, an explosion of a dirty bomb in a public place), natural disasters (hurricanes, earthquakes, etc.), accidental incidents (a plane crash into a building or area, an unintentional contamination of a company's food products, etc.) or any other type of or current or historical hazardous incident. The invention may be used by all types of stakeholder, including governments and government agencies, large corporations, small companies, local areas, persons, etc.

In the following description in order to provide a full understanding of the invention specific details are described with respect to preferred embodiments of the system; however the preferred embodiments should be interpreted as illustrative and not in a limiting sense and a wide range of changes can be made by those skilled in the art without departing from the scope of the invention. For clarity of description we utilize the specific example of incidents that involve the intentional widespread dissemination of a toxic agent in a manner that can cause human morbidity and mortality. Such dissemination could be in the form of a widespread release of a toxic inhalation agent into the air, the introduction of a toxic ingestion agent into a food product that has widespread distribution, etc.

In this selected example the characteristics that can affect the impact of the incidents include the quantity of contaminant released, the characteristics of the agent (such are toxicity, attack rate, etc), the breadth of distribution of the agent, the population density in the areas contaminated, the availability of medical resources to mitigate the effects of the toxin, the detoxification window (the length of time following intoxication during which medical mitigative actions are effective), etc. However the same system and methods apply to the entire range of possible types of incident and the characteristics may be any of a wide range of possible characteristics. It is also to be understood that the claims that follow are to cover all generic and specific features described herein.

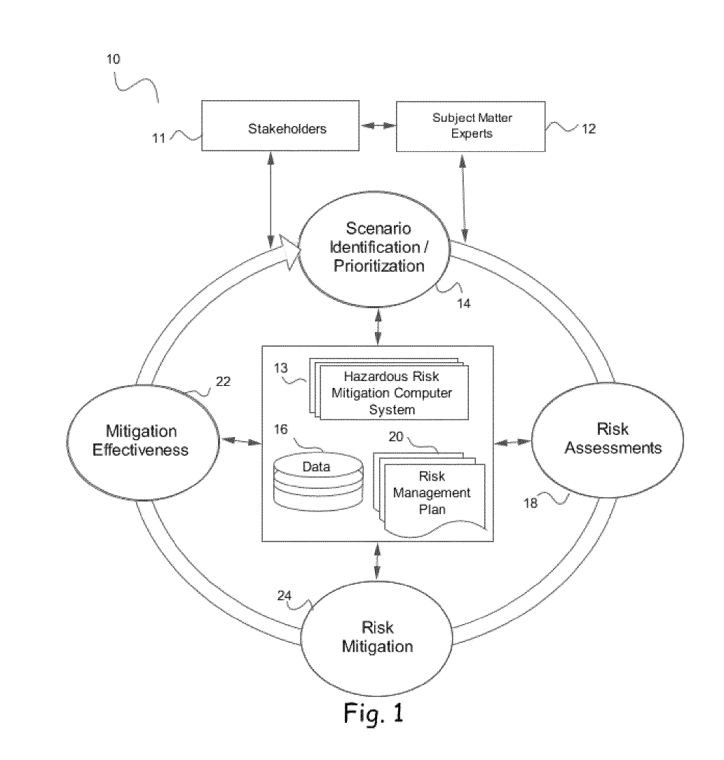

FIG. 1 shows a schematic diagram of one system 10 of the invention. This specific embodiment is of a hazardous risk mitigation system to mitigate the effects of an incident involving the widespread inhalation or ingestion of a lethal quantity of a toxin by a large population.

This preferred embodiment restricts greatly the range of characteristics of incident, but even with this great limitation the range of different types of hazardous incidents that may be encountered by stakeholders is enormous, as there are many different types of toxic inhalation and ingestion agents, many different modes of release, many different geographies over which they could be released, many different quantities of agent that could be released, etc. Ideally, the stakeholders in such incidents would have a complete set of resources to respond to all such variations, but almost invariably the resources available for response are limited and so it is necessary to identify and prioritize those specific types of incident that can be effectively mitigated within the available resources.

The system 10 provides methods and computer programs that will enable stakeholders who have the responsibility to effectively defend complex systems assets against hazardous risks to identify, plan, develop, implement, validate, refine and continuously improve the abilities, approaches and resources that they require for optimal mitigation of the adverse outcomes of such hazardous incidents.

Frequently there are many different sets of stakeholders 11 that are responsible for various phases of the optimal response to a hazardous incident. For example, in the preferred embodiment of a widespread attack with a toxin, prior to an incident it is necessary to prepare for such an attack by positioning critical antitoxins in areas around the country in such a way that they can be rapidly deployed, for which activity the stakeholder may be a federal agency such as the Centers for Disease Control. During the initial stages of the incident the capability to detect the existence of the incident is key, and the stakeholder that has this responsibility varies with the specific details of the incident, for an aerosolized release of an agent this may be federal agencies or programs (for example the federal BioWatch program); for a food contamination this may be the food producer or a sector specific agency such as the U.S. Department of Agriculture or the U.S. Food and Drug Administration, etc. During later stages of an incident the medical sector, such as hospitals, physicians, etc. may have the responsibility. This potentially wide range of stakeholders with very different skill sets and focus frequently presents a great challenge in ensuring effective incident response. Each stakeholder must know the roles and responsibilities that they hold, the responsibilities that are held by others, and the best mode for efficient handoff of responsibility between each of these stakeholders. Each stakeholder must be capable of effectively executing their own responsibilities and must also be aware of the responsibilities of their partner stakeholders, but for efficiency of the training and validation of effectiveness it is preferable that each stakeholder focus on their specific responsibilities.

The system 10 accomplishes all of the above through a systematic, science-based process that evaluates and quantifies both the direct and indirect consequences of potential improvements in the various actions and abilities required to mitigate the impacts of hazardous incidents. The results of this system 10 provide justification for stakeholders to advocate and compete for funding and other required resources by using data and forecasts for how preparedness can be improved, the relative benefits of improvement of each of the different areas of capability, and the estimated reductions in incident impacts that will result from making these improvements. The system 10 also develops and provides stakeholders with a Risk Management Plan that details their roles and responsibilities and how they fit in with the roles and responsibilities of other stakeholders, an evaluation of their current level of performance of each of their areas of responsibility and a set of Best Practices to help optimize the achievement of improvements in that performance.

The system 10 may be used by any group of stakeholders 11 that need to improve their abilities to prevent, protect, respond and recover from potentially hazardous incidents for which their have responsibility. The stakeholders 11 implement the system 10 with guidance and assistance of a group of Subject Matter Experts 12 who are skilled in that art. This implementation is guided and aided by the Hazardous Risk Mitigation Computer System 13 that implements the processes described herein. Throughout its cycle of performance the system 10 collects all relevant data, anonymizes such data to preserve the privacy of stakeholder sensitive information, stores in a data bank 16, and processes the data to generate information for use in the current implementation and to inform subsequent implementations.

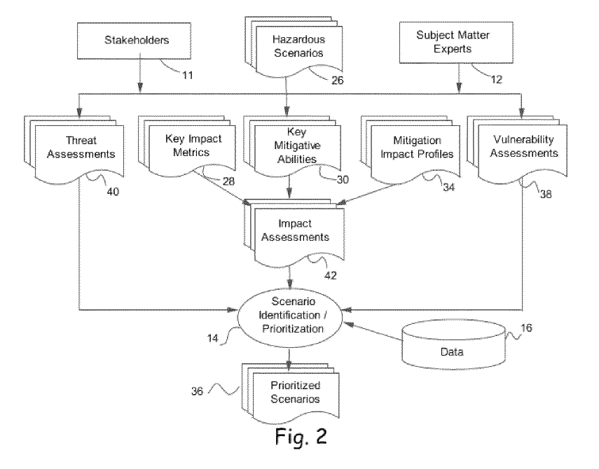

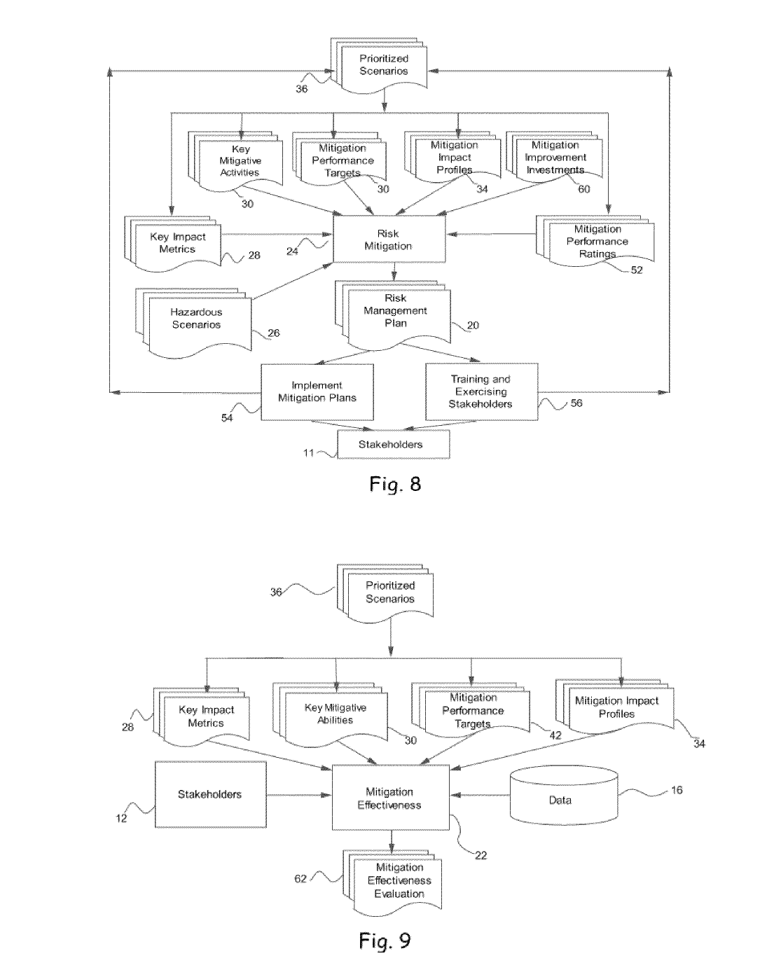

The system 10 includes a Scenario Identification and Prioritization process 14 (which is illustrated in FIG. 2) that identifies and prioritizes the scenarios that are of greatest importance for remediation. In a preferred embodiment, the system 10 analyses the total risk associated with the each of the high priority scenarios identified by process 14 through a Risk Assessment process 18. This Risk Assessment process 18 (which is illustrated in FIG. 4) determines those activities and abilities that are required to mitigate the impacts of the selected scenarios, identifies those activities that are already being performed and those abilities that already exist and details the plan for utilizing available resources to optimally mitigate the risk of the high priority scenarios. In the preferred embodiment, the system 10 then implements the Risk Mitigation program 24 (illustrated in FIG. 8). This Risk Mitigation program 24 summarizes the entire program required for optimal mitigation of the incident given available resources, including all the significant conclusions and recommendations, in a comprehensive Risk Management Plan 20 that is provided to stakeholders 11 and Subject Matter Experts 12 and then guides the stakeholders through the implementation of the plan. Following completion of the implementation it is important to evaluate the effectiveness of the implemented programs and the extent to which they have successfully reduced risk associated with the selected high priority scenarios. The system 10 evaluates this effectiveness though a Mitigation Effectiveness program 22 (illustrated in FIG. 9).

As illustrated in FIG. 1, the operation of the system 10 is cyclical. Each cycle starts with the prioritization of the relative risk of different scenarios, but during the cycle those risks may change due to the due to the operation of the system itself or due to changes in many other factors external to the system 10. Accordingly, at the conclusion of each cycle the hazardous scenarios are re-prioritized through the process 14, and the entire cycle recommences.

FIG. 2 illustrates a block diagram of one embodiment of a Scenario Identification and Prioritization process 14 that is used for determination of the relative priority of the various potential hazardous scenarios 26. The preferred embodiment of the process 14 is through evaluation of the risk of various types of scenario and the prioritization of those scenarios according to the magnitude of the risk that they present. This risk evaluation is then used by the system 10 to identify those types of scenarios that are the highest priority for the investment of resources and funds for risk mitigation.

The Scenario Identification and Prioritization process 14 commences with formation of a group of Subject Matter Experts 12 who have specific knowledge and expertise of the types of hazardous scenarios that may be significant to the stakeholders 11, and an expert elicitation from these Subject Matter Experts 12 of the risk associated with each type of scenario identified.

The risk associated with a hazardous incident is commonly defined by those practiced in the art as the product of the threat of occurrence of the incident multiplied by the vulnerability of the target to that type of incident and further multiplied by the potential consequences of such an incident were it to be successful.

The threat of an incident is an assessment of the magnitude of likelihood of that type of incident occurring, and is assessed by the Threat Assessment process 40. The threat is generally controlled by forces that are beyond the control of the stakeholders, for example the threat of a natural disaster is largely controlled by nature, the threat of a terrorist attack is largely controlled by the terrorists, etc. For intentional attacks the Threat Assessments 40 are typically elicited from law enforcement or intelligence agencies that perform such assessments. Such assessments are frequently classified in such a way that the only information that is available to the Subject Matter Experts 12 is in general terms regarding a general type of scenario, for example “the threat of a terrorist attack on an airplane is higher than the threat of such on attack on an individual automobile”. If no such assessments are available for a specific group of types of incident then all members of that group are assumed to have equal threat.

The Vulnerability Assessment 38 of an incident is an assessment of the probability of identified potential targets being harmed by successful incidents with the specific form of scenario being evaluated. The system 10 performs such investigations using teams comprising of the Subject Matter Experts 12 that are practiced in the art and the stakeholders 11 that are responsible for the protection and maintenance of each target being investigated.

The Impact Assessment 42 of a scenario is an assessment of the potential impact of incidents with that particular form of scenario. This is evaluated as the product of the potential impact of an incident were it to be completely unmitigated multiplied by a quantification of the probable effectiveness of mitigation of that impact due to the activities of prevention and response by the stakeholders in the incident.

Impact Assessments are rendered based on a set of Key Impact Metrics 28. These Key Impact Metrics 28 are evaluated as measurements of the types of potential harm that could be caused by the incident and are established for a particular set of incidents at the commencement of the implementation of the system 10. For example, the Key Impact Metrics 28 for incidents that cause direct human harm could be the number of severe human morbidities and the number of human mortalities, the Key Impact Metrics 28 for incidents that do not cause direct human harm could be the sole metric of the economic loss caused by the incident.

In the embodiment of the Impact Assessment process 42 depicted in FIG. 2 the stakeholders 11 and subject matter experts 12 develop two distinct sets of data on the impact, the Key Mitigative Abilities 30 characterize the key activities, abilities and organizational approaches required to optimally mitigate the impact of the studied incident, and the Mitigation Impact Profiles 34 profile the effectiveness of those activities in mitigating the Key Impact Metrics of the incident.

The preferred embodiment of the Impact Assessment process 42 is an iterative process, whereby the system 10 is first implemented by an expert elicitation from a team comprising the stakeholders 11 and Subject Matter Experts 12 with specific knowledge and expertise of the actions and abilities required for optimal mitigation of hazardous scenarios of the type being processed. During this elicitation the team renders their best judgments of the Key Mitigative Abilities 30 and the Mitigation Impact Profiles 34. These are then synthesized, by the Subject Matter Experts 12 to generate Impact Assessments 42 that quantify the expected impact of the mitigative activities on the Key Impact Metrics 28. These Impact Assessments 42 are then synthesized with the Threat Assessments 40 and Vulnerability Assessments 38 to yield an initial set of Prioritized Scenarios 36. In subsequent iterations of the Scenario Identification and Prioritization process 14 the Mitigation Impact Profiles 34 that are developed as a part of prior Risk Assessments 18 are used together with the Data 16 that are collected as a part of the operation of the system 10 to inform re-assessment of these decisions to ensure that the specification of the Prioritized Scenarios 36 are continuously modified to reflect changing threat conditions and changing levels of the Key Mitigative Abilities 30.

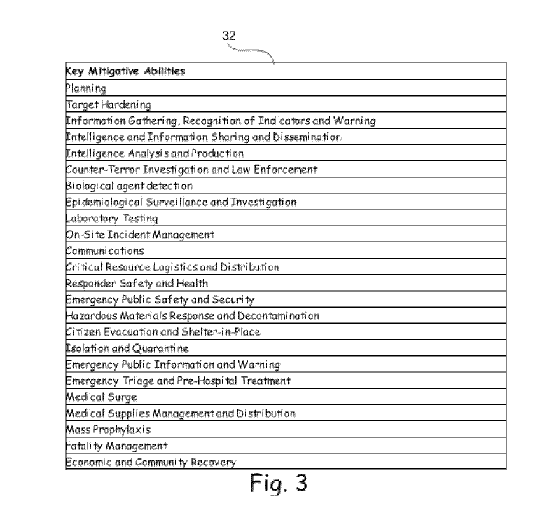

FIG. 3 shows an example 32 of the Key Mitigative Abilities 30 that may be crucial for effective mitigation of an incident of an aerosolized agent release of a toxic agent.

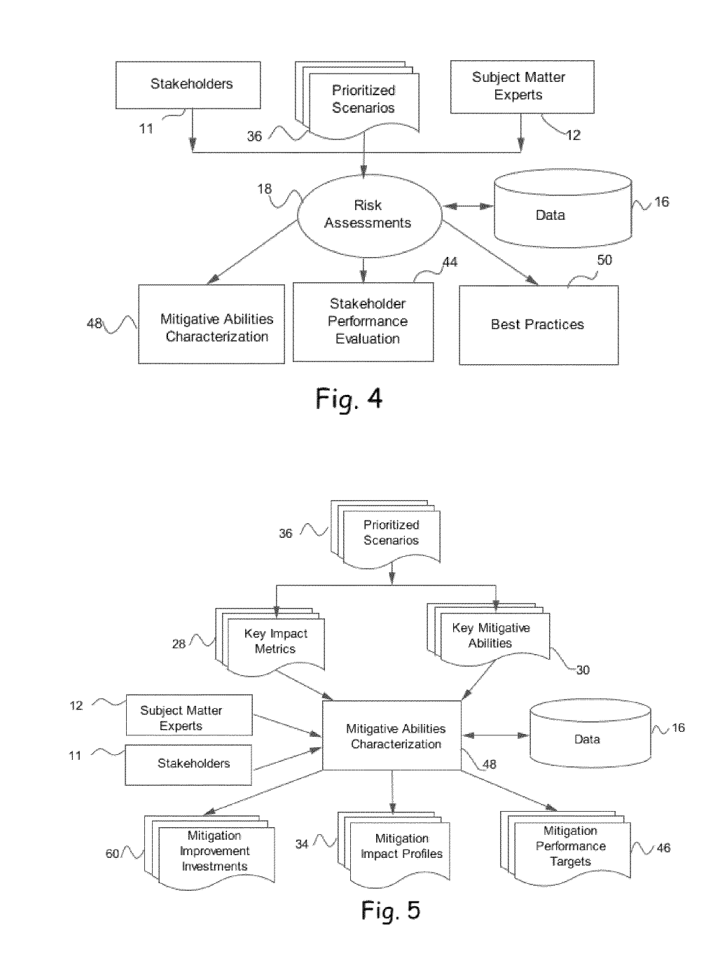

FIG. 4 illustrates a block diagram of one embodiment of the Risk Assessment process 18 that characterizes two distinct processes: Mitigative Abilities Characterization 48 and Stakeholder Performance Evaluation 44 and generates a set of Best Practices 50. The Mitigative Abilities Characterization process 48 (illustrated in FIG. 5) produces algorithms and data sets that describe the process to evaluate the effect on Key Impact Metrics 28 of each Key Mitigative Ability 30. The Stakeholder Performance Evaluation process 44 (illustrated in FIG. 7) characterizes the process to evaluate the level of performance by the stakeholders of each Key Mitigative Ability 30. The Best Practices 50 are a set of descriptions for each Key Mitigative Ability 30 of the processes to be performed to optimally perform that ability.

FIG. 5 illustrates a block diagram of one embodiment of the Mitigative Abilities Characterization process 48. This embodiment has the form of three data sets:
The Mitigation Impact Profiles 34 define a set of data and/or algorithm(s) that relate varying levels of performance of each Key Mitigative Ability 30 to the impact that level of performance has on each of the Key Impact Metrics 28.
The Mitigation Performance Targets 46 characterize the target level of performance of each Key Mitigative Ability 30 as a percentage, where 100% indicates the most complete level of performance of that ability.
The Mitigation Improvement Investments 60 are expressed as a percentage that characterizes the relative cost of improving each Key Mitigative Ability 30 by a specified quantity relative to the cost of improving other Key Abilities by that same quantity.

These data sets are initially established by expert elicitation from selected Subject Matter Experts 12 and Stakeholders 11, but as successive implementations of the system 10 are performed the data that are generated by each of these implementations are input to the Data base 16, where the data are anonymized and used to generate and validate the expected or target values for each of these data sets.

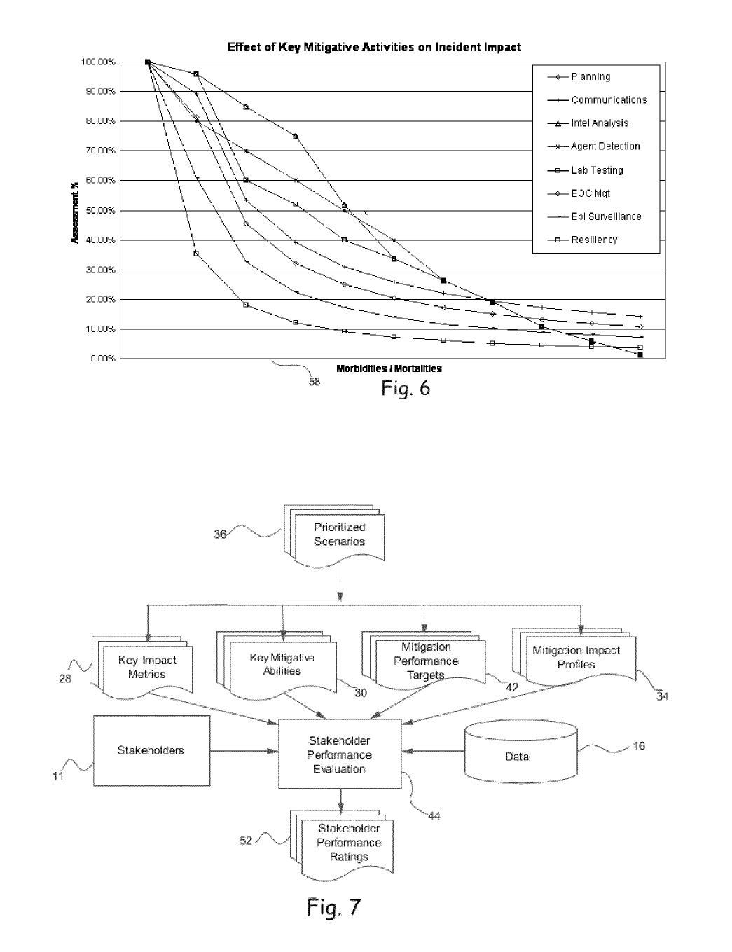

FIG. 6 shows a notional way 58 that Key Impact Metrics 28 of morbidity and mortality may be affected by changes in the Mitigative Impact Profiles 34.

FIG. 7 illustrates a block diagram of one embodiment of the Stakeholder Performance Evaluation process 44 that enables the system 10 to assess the Stakeholder Performance Ratings 52. The Stakeholder Performance Ratings 52 describe the technical abilities possessed by the stakeholder that enable the stakeholder to exhibit each Key Mitigative Ability, and identify:
The Key Mitigative Ability 30 that is to be assessed.
The Key Impact Metric(s) 28 that it affects.
A set of data, questions, situation assessments and actions that when answered or otherwise addressed by a stakeholder enable evaluation of the stakeholder's level of effectiveness and timeliness in executing the Key Mitigative Ability 30, expressed as a percentage of the Mitigation Performance Target 42. Each specification details the metric to be used in the evaluating the response and the algorithm that enables the effect of the mitigative activities to be synthesized into an overall percentage change in the assessment of the mitigation effect on each Key Impact Metric 28

This Stakeholder Performance Evaluation 44 is performed by leading the stakeholder(s) that are responsible for that ability through the series of questions that are detailed in the Mitigation Impact Profile 34 for that ability. This process will be described in detail later in this document.

FIG. 8 illustrates a block diagram of one embodiment of the Risk Mitigation process 24. This process synthesizes the various characteristics that are revealed by the hazardous risk mitigation system 10 into a Risk Management Plan 20 and then implements that plan in two forms: as a proactive plan for remediating potential incidents and as an action plan for response to currently evolving incidents.

The Risk Management Plan 20 identifies:
the roles and responsibilities of each stakeholder,
the activities that each stakeholder should perform to optimally carry out those responsibilities,
the events that trigger the execution of those activities,
how and in what time frame that execution should be accomplished to optimize the response,
how to receive relevant, appropriate information on the incident from the previous stakeholder and how to collect and hand off appropriate information to the next stakeholder,
all other key issues relevant to the performance of the various responsibilities of each stakeholder.

The Risk Management Plan 20 also details the improvements in performance of their responsibilities that are required of each stakeholder. The implementation of those improvements is accomplished through the Implement Mitigation Plans activity 54 and also the Training and Exercising Stakeholders process 56 which trains and exercises the stakeholders in their responsibilities in the Risk Management Plan 20 and how to optimally carry out those responsibilities.

The Risk Mitigation process 24 also enables utilization of the knowledge synthesized by the system 10 as an action plan for response to currently evolving incidents. In such an action plan known data on the evolution of currently evolving incidents currently evolving hazardous scenarios 26 are entered into the Risk Mitigation process 24, and the process synthesizes these data together with the other system data to produce a field operations guide for each stakeholder that details the status of each of the pre-scripted tasks that should have been completed or should be initiated by that stakeholder during the subject time period and a description of each activity that they should perform during this time period to mitigate the impacts of the incident.

FIG. 9 illustrates a block diagram of one embodiment of the Mitigative Effectiveness evaluation process 22 which evaluates the degree to which the Risk Mitigation 24 has successfully reduced risk associated with the selected high priority scenarios.

The Stakeholder Performance Evaluation 44 illustrated in FIG. 7, the Training and Exercising Stakeholders process 56 illustrated in FIG. 8 and the Mitigative Effectiveness process 22 illustrated in FIG. 9 may be performed in many ways. Three embodiments of such performance are:
As of a functional training exercise, during which the incident is enacted using less non-hazardous or non-hazardous agents and the actual performance of the stakeholders is measured in terms of the level of accomplishment of the activity, the time taken to perform the activity, etc. and such measurements are used to generate the performance ratings.
As an activity within a “table top” training exercise involving all of the stakeholders in the incident. In a preferred embodiment the scenario is simulated using a computerized simulation system that shows the evolution of the incident both spatially and temporally using a graphical user interface and Graphical Information System mapping system. During the simulation the evolution of the incident is paused at each critical point and the stakeholders are questioned as to the nature and timing of the actions that they would undertake during a real incident at that stage of evolution. The answers are used to generate the performance ratings.
By observation of the performance of stakeholders during current real incidents or by analysis of historical incidents of a type similar to that being evaluated. The stakeholders in the observed incident are questioned on the nature and timing of the actions that they are undertaking or had undertaken during the real incident at each stage of evolution. The answers are used to generate the performance ratings.

A preferred embodiment of the system 10 utilizes training exercises as a key vehicle for both collecting the data required for operation of the system and also for disseminating the information to the stakeholders and training them in the appropriate implementation of the Risk Management Plan 20.

To achieve maximum effectiveness of such exercises it is important that the stakeholders are able to focus on a specific scenario of the selected type of incident. Through focusing on a specific scenario the stakeholders are able to envision themselves in the middle of a real incident and through that visualization to render the specific types of accurate volume and timing information that are essential for ability assessment. An important factor in selection of the scenarios for use in this preferred embodiment is that they are not critically dependent on the accuracy of the details of the incident profile and resulting sequelae and outcomes. Stakeholders must have the ability to respond to every potential scenario. So for example, in the scenario of a release of a toxic inhalation agent, regardless of whether a mildly toxic agent is released over many months, or an extremely toxic agent is released in a single day, and regardless of whether the volume of agent released is large or small, the stakeholders in the incident must be able to respond to the incident effectively, so regardless of the details of the scenario, the data yielded are relevant. Further, in many scenarios the only information that is observable during the early stages of incident evolution is the evolving pattern of impacts of the incident (for example the illnesses that are caused by the agent release). So during the early phases of exercises using such scenarios it is only necessary for the scenario to describe patterns of the impacts for which preparedness is to be evaluated, and any scenario for which that pattern of outcomes is credible will enable the system 10 to provide valid information, regardless of the details of the scenario.

These factors are important due to a frequently occurring requirement to have comparability of exercise scenarios. At the national level, different states and agencies compete for funding of mitigative activities and to be successful it is frequently necessary to provide justifications of the need for investment of resources, and for such investment justifications to have comparability with those of other competitors. Consequently if the results of the system 10 are to be used by states and agencies as justification for federal funding then it is important that the system ensures comparability between implementations across these different states and agencies. The flexibility in scenario selection described above creates the ability for a scenario to be specified in general terms and then customized to the individual interests of specific groups of stakeholders, thus maintaining comparability while simultaneously affording specificity and relevance to specific stakeholder interests. Further, the maintenance of such comparability across multiple stakeholder groups enable the resulting assessments to be used to establish regional/national averages without divulging confidential data on the stakeholders in such exercises, which data will improve the identification of national deficiencies, will provide more complete information to identify essential areas for remediation and will facilitate relative justification for grants and/or expenditures.

In the preferred embodiment of the system 10, the process for collecting the data required for generation of the Risk Management Plan 20 is to elicit such data through a functional or table-top exercise process that exercises representative scenarios for selected types of incident. During such exercises the stakeholders are exposed to the evolution of a simulation of one or more high priority scenarios and as the incident evolution progresses through the various key stages the stakeholders are asked a sequence of key questions regarding their actions in response to the conditions and knowledge level at that stage. The answers to those questions enable the system 10 to evaluate the operational and organizational characteristics that exist for response to the incident, including the roles and responsibilities of various stakeholders, the management structure and chain of authority that controls and monitors the required mitigative activities, the timing of the implementation of such activities, etc.

A convenient approach to set up exercises of the system 10 in the preferred embodiment is to determine the type of scenario to be benchmarked by reference to prior real incidents that have been of concern to the stakeholders. If the stakeholders already have a dataset of case (e.g. illness) distribution that exhibits the selected pattern then the system 10 can use that dataset for the exercise. If no such dataset is available, then it can be created by first choosing the general parameters that are desired to be benchmarked (for example the volume of cases (e.g. patients) affected, the time period and geographic range over which cases occur and the time profile and volume of illness and mortalities that occur as a result of the incident, and then creating a dataset of cases that fit these parameters. The dataset that results from such a process is as appropriate for the system 10 as a dataset generated from a real, previous incident. Note that the process itself does not to compute or show any information about the vector that transmits the incident or its distribution; all of its data are on the impacts of the incident, not the causes, and so no causal data are required in the dataset.

The following describes the preferred embodiments of the implementation of the system 10 as it would be used in a table top exercise of a massive, rapidly evolving multi-state foodborne terrorist attack where the exercise is guided by an exercise facilitator and involves stakeholders with responsibility for such attacks, however the preferred embodiments should be interpreted as illustrative and not in a limiting sense and a wide range of changes can be made by those skilled in the art without departing from the scope of the invention.

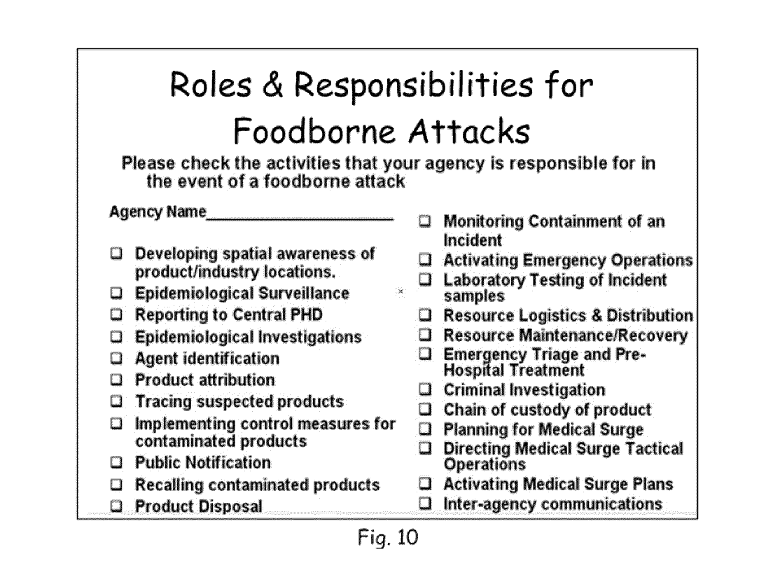

The exercise would normally commence with an initial introduction in which all the participants introduce themselves and their affiliation and the facilitator(s) describe the process to be used. After the initial introduction the exercise facilitator starts the Hazardous Risk Mitigation Computer System 13 which displays a form similar to that shown in FIG. 10. Copies of this form are distributed, and all attendees are asked check off the appropriate areas on this form to identify the roles that they play and areas of responsibility that they have for prevention and response to foodborne terrorist attacks.

Following identification of the roles and responsibilities, the Hazardous Risk Mitigation Computer System 13 starts a computerized incident simulation that displays a simulation of the manner in which outcomes would present during the evolution of the selected scenario. In the preferred embodiment this evolution is shown using a computerized simulation using a Graphical Information System (“GIS”) to display that evolution.

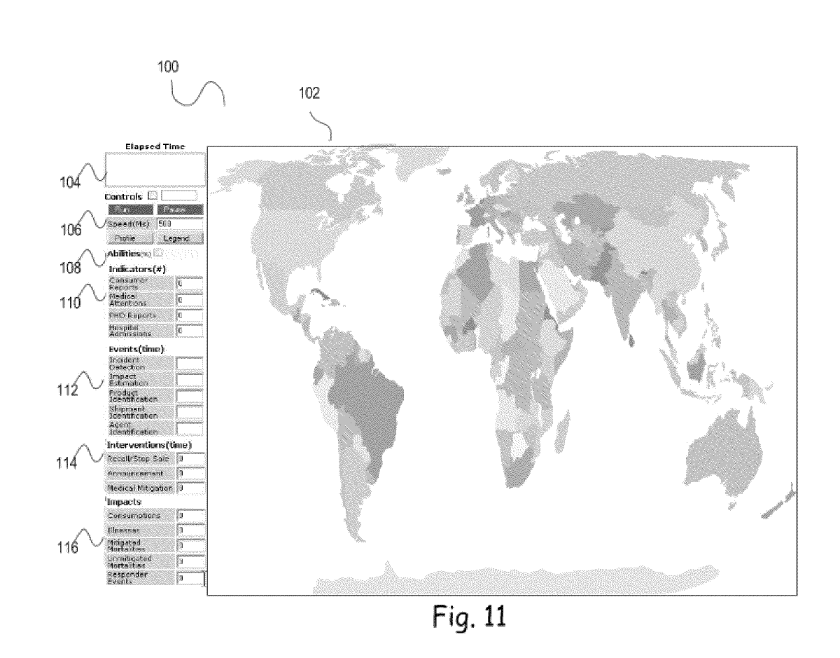

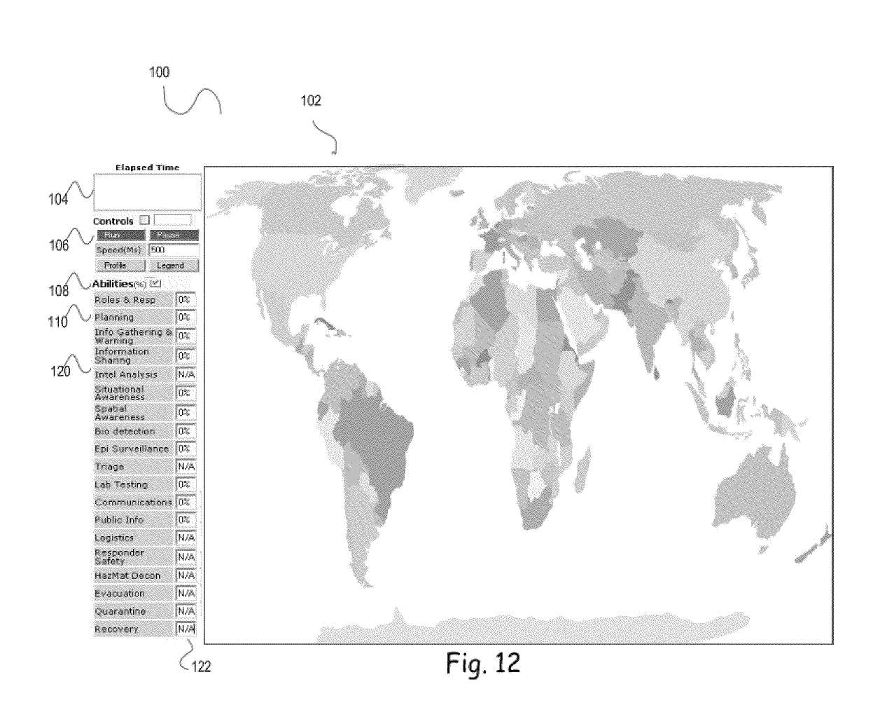

FIG. 11 shows the opening screen 100 of the computerized simulation. The main body of the screen displays a GIS Map 102, which initially depicts a map of the entire world. On the left of the map is an area that displays the information of the current state of evolution of the scenario. At the top of the area is an Elapsed Time display 104. As each simulated hour passes the Hazardous Risk Mitigation Computer System 13 depicts the status of the simulation at the current hour and the Elapsed Time display 104 displays the current simulation time as a date and hour in the day (e.g. Aug. 24, 2007, 17:00 hrs).

Below the Elapsed Time display 104 is the Simulation Controls area 106, containing a set of controls (check boxes, buttons and input boxes) that enable facilitator to control the simulation, for example to start the simulation, pause it, stop it, change the speed with which the simulation progresses, etc. Below the Simulation Controls 106 is the Abilities Entry area 108 that is used to enter the values of the Stakeholder Performance Ratings 52 elicited during the exercise. On the initial display screen this area is hidden to increase the clarity of the display. Below the Abilities Entry area 108 is the Indicators Display area 110 which is used to display the Key Indicators of the simulation. These Key Indicators are the various consequences of the incident that can be observed during the evolution of the incident and may serve to inform the stakeholders of the existence and state of evolution of the incident, but excluding the Key Impact Metrics 28 of the incident which are displayed in a separate area below. In the example shown the Indicators Display area 110 shows that there are four Key Indicators:
Consumer Reports—these are the reports to a stakeholder, for example one of the companies that produced, distributed or sold the product, the local Health Department, etc., from persons who have become ill and suspect that the illness is due to consumption of a contaminated food.
Medical Attentions are reports from doctors, typically to the local Health Department, that they have recently treated a patient for what appeared to be food poisoning.
PHD Reports are reports from various sources to the state Public Health Department of cases that appear to be related to the same food poisoning incident.
Hospital Admissions are reports from hospitals to the state Public Health Department of clusters of cases that appear to be related to the same food poisoning incident.

Below the Indicators Display area 110 is the Events Display area 112 that displays the Key Events of the incident. The Key Events of the incident are those events that take place that mark a significant change in the stage of evolution of the incident that impacts stakeholders. In the example shown the Events Display area 112 shows five Key Events:
Incident Detection—this event occurs when one or more of the stakeholders first detects that an incident is occurring.
Impact Estimation—this event occurs following Incident Detection when a stakeholder completes an analysis of the potential total impact of the incident, for example that the incident is local and will only affect a small number of consumers, the incident has a national scope and will affect a large number of consumers, etc.
Product Identification—this event occurs when the type of product that is contaminated is identified by stakeholders.
Shipment Identification—this event occurs when the specific shipments of product that are contaminated are identified by stakeholders.
Agent Identification—this event occurs when the specific agent that is contaminating the product is identified by stakeholders.

All of these events are significant because they may trigger stakeholders to take specific actions (for example to announce to the public that there a food contamination incident is occurring) or invoke other stakeholder resources.

Below the Events Display area 112 is the Interventions Display Area 114 that displays the time at which a Key Intervention in the evolution of the incident is invoked. The Key Interventions in the evolution of the incident are those interventions that cause a significant change in the evolution of the incident. In the example shown the Interventions Display Area 114 shows three Key Interventions:
A Recall/Stop Sale—this intervention occurs when one or more of the stakeholders instruct the producers, distributors and retailers to recall (i.e. return to the producer or another controlled location), stop sale (i.e. cease selling the product to consumers) or stop movement (i.e. cease allowing the product to move through its distribution chain) of the entire contaminated product.
An Announcement—this intervention occurs when one or more of the stakeholders makes a public announcement to the media of the existence of the incident and of mitigative actions that consumers should take to avoid contamination, for example to stop consumption of the contaminated product
A Medical Mitigation Announcement—this intervention occurs when one or more of the stakeholders makes an announcement to the medical community of the existence of the incident and of mitigative actions that the medical community should take for treat patients who are suspected of being ill because of consumption of the contaminated product, for example specific forms of medical treatment, requirements for quarantine, etc.

Below the Interventions Display Area 114 is the Impacts Display area 116 that displays the volume of each Key Impact Metric of the incident at the current scenario elapsed time. In the example shown the Impacts Display area 116 shows five Key Impact Metrics:
Consumptions—the cumulative number of consumption of the contaminated product to the current simulation time (this is usually hidden during the initial run of the system, as described below).
Illnesses—the cumulative number of patient illnesses caused by consumption of the contaminated product to the current simulation time.
Mitigated Mortalities—the cumulative number of number of patients who have died as a result of consumption of the contaminated product up to the current simulation time, but where the patient has received medical mitigative support according to the medical practices that are appropriate for the current level of information that has been announced to the medical community. For example, if no announcement of the incident has been made to the medical community then it is assumed that all hospital patients have received the normal mitigative treatment for the patient symptoms (unfortunately, most foodborne illnesses present with very similar symptoms during the initial stages, so the normal mitigative treatments are unable to mitigate many of the effects of intoxications).
Unmitigated Mortalities—the cumulative number of patient mortalities to the current simulation time due to consumption of the contaminated product where there has been no medical mitigation.
Responder Events—the cumulative number of casualties of first responders up to the current simulation time.

The initial display screen 100 of the system is displayed with all of the areas 104-116 blank or zero, indicating that the scenario evolution has not started.

FIG. 12 displays the screen that appears when the “Abilities” checkbox in the Abilities Entry area 108 is checked. This causes the Abilities Entries list to be displayed as illustrated in the figure. The Abilities Entries list comprises a list of the Mitigative Ability Name 120 and value 122. If that Key Mitigative Ability 30 is being exercised in the current exercise the Stakeholder Performance Evaluation 122 shows as a percentage value, but if the Key Mitigative Ability 30 is not being exercised in the current exercise then it shows “N/A” (Not Applicable).

The facilitator will run a total of three simulations of the incident during the exercise, each of which will represent the evolution of the simulation with the same abilities being exercised, but with different values for those abilities. In this exercise the Key Abilities to be exercised are Roles & Responsibilities, Planning; Information Gathering and Warning; Information Sharing & Analysis; Situational Awareness; Spatial Awareness; Biological Detection; Epidemiological Analysis; Laboratory Testing; Communications; and Public Information Distribution.

The first simulation is run with all abilities to be exercised set at the 0%, so simulates the way outcomes would present due to an incident of the selected scenario if it were never detected and there were there no interventions at all (i.e. the worst case scenario). Consequently in this simulation all of those abilities are set at 0% and all other values are set at N/A.

The exercise facilitator starts the exercise by clicking on the “Run” button in the Simulation Controls area 106, which causes the Hazardous Risk Mitigation Computer System 13 to start the simulation, which is shown by the Elapsed Time display 104 displaying the (simulated) current date and time. The scenario depiction typically starts at a point in time that is somewhat before the first occurrence of scenario impacts, typically at midnight on the day prior to the first presentation of impact. Following the start of the simulation the Hazardous Risk Mitigation Computer System 13 automatically progresses through the evolution of the incident one hour at a time. As each hour passes the Hazardous Risk Mitigation Computer System 13 updates the Elapsed Time display 104 to show the simulated time in days and hours, the GIS Map 102 moves and resizes to show all the locations that are impacted by the incident at the current time, the Indicators Display area 110 shows any changes in the Key Indicators, and the Impacts Display area 116 shows any changes in the Key Impact Metrics 28.

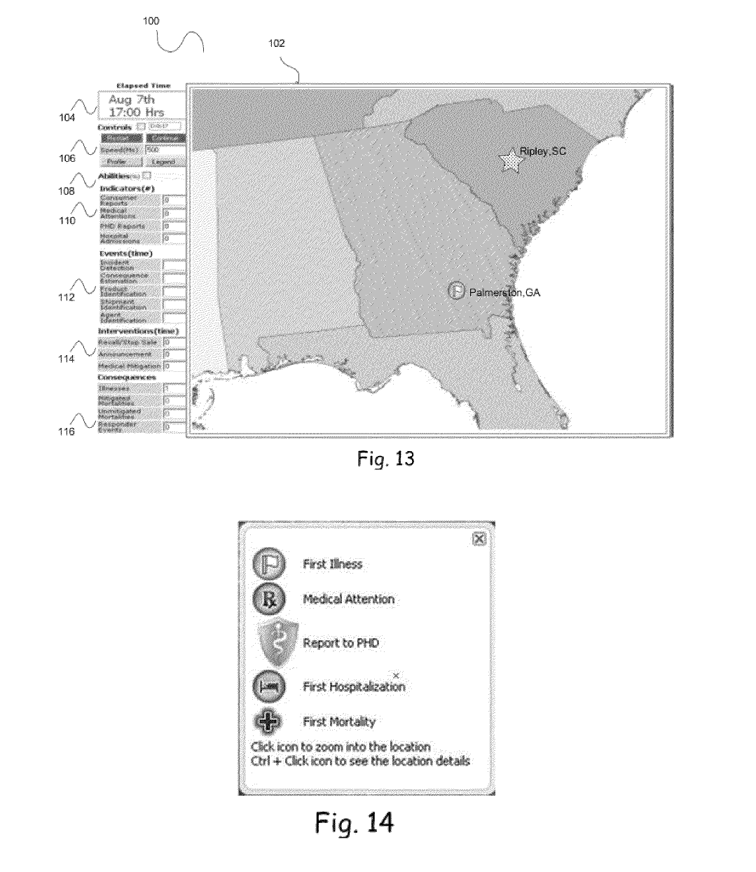

FIG. 13 illustrates the display as it appears when the first illness occurs in the (fictitious) city of Palmerston, Ga. The Elapsed Time display 104 shows the current simulation time which is August 7 at 17:00 hours. This time is 17 hours following simulated time at the start of the simulation, which was midnight on August 6. The GIS Map 102 shows a map of the area surrounding the location of the first impact and displays the location where the contamination occurred as a star shaped icon with a dotted interior together with the name of the location (all names on this GIS Map 102 are fictitious) and the Impacts Display area 116 shows that one illness has occurred at Palmerston, Ga.

The Hazardous Risk Mitigation Computer System 13 automatically progresses through the evolution of the incident one hour at a time until a key event occurs that automatically pauses the evolution, or the exercise facilitator pauses the evolution manually by clicking on the Simulation Controls 106 “Pause/Continue” button. As new locations are first impacted by the contamination the Hazardous Risk Mitigation Computer System 13 reflects that by showing an icon on the map. Each time the incident progresses so that a new stage of incident evolution occurs at a location (for example, the first patient at that location moves from illness to accessing medical attention) the location icon is changed to reflect that progress. The icons can be shown at any time by clicking the “Legend” button in the Simulation Controls area 106. The icons that are displayed for the preferred embodiment of a widespread attack with a toxin are illustrated in FIG. 14, where the various icons in sequence from the top of the legend indicate the first illness at that location due to the contamination incident, the first time a patient with one of those illnesses seeks medical attention, the first such medical attention that is reported to the state or local public health department, the first patient that is admitted to hospital, and the first mortality.

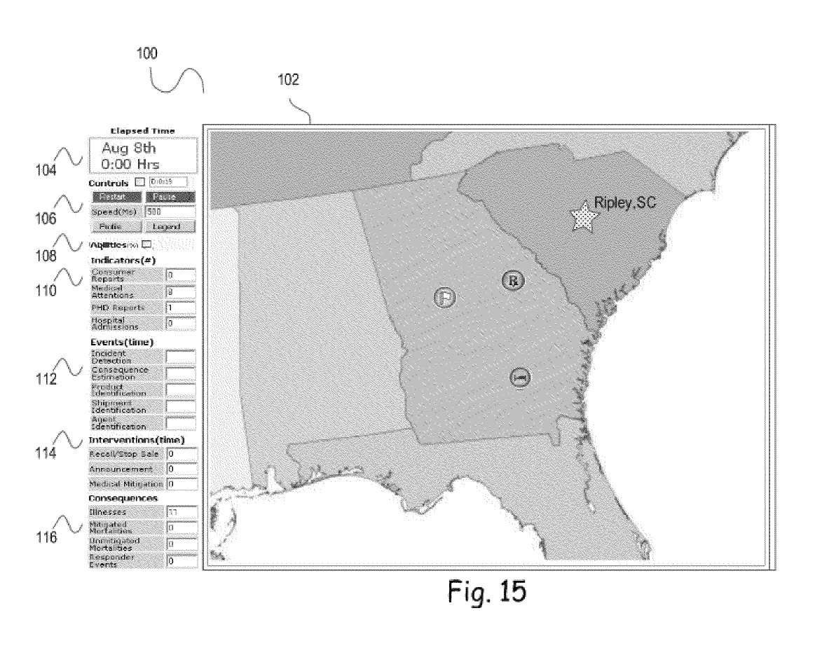

FIG. 15 illustrates the display as it appears twenty-four hours following the start of the simulation. At this point in time three locations have been impacted by the contamination. The names of the first two locations have been hidden to reduce the clutter of the screen and the icons have changed to show the hospital icon at the Palmerston location (indicating that the first hospitalization has occurred at that location) and similar changes at other locations.

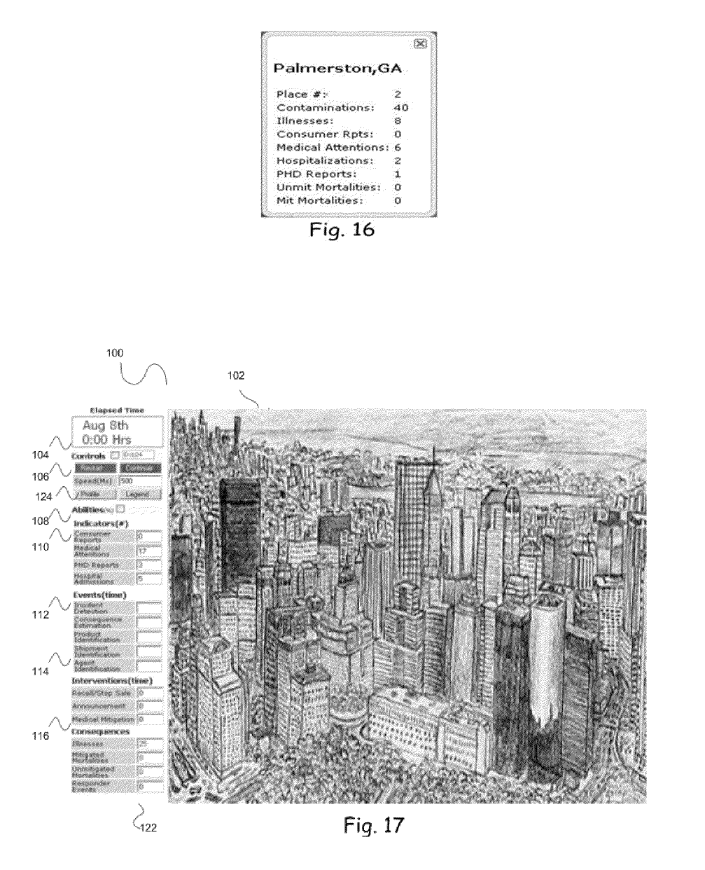

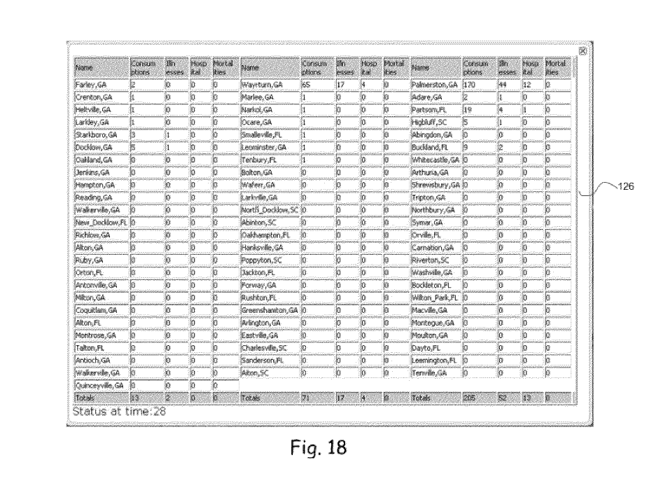

At any time the facilitator can click on a location icon to display the complete status at that location as illustrated in FIG. 16 or can Ctrl+Click or double-click on a location icon to zoom into the map of the location as illustrated in FIG. 17. Also at any time the facilitator can display the current impact of the incident at all locations by clicking on the “Profile” button 124, and a complete Profile Display 126 of the values of all Key Impact Metrics 28 at all locations is displayed as illustrated in FIG. 18.

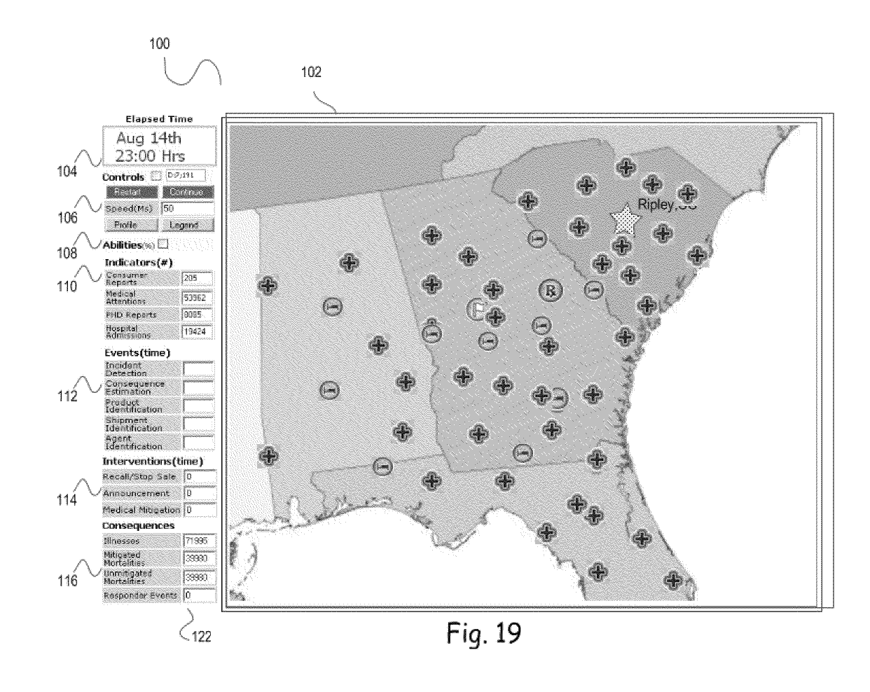

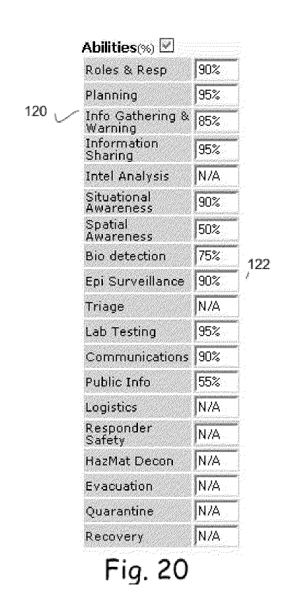

This first simulation is performed under the worst case scenario, when all of the activities of response are programmed into the simulation to occur at the latest possible time so that they have no beneficial effect on the incident impacts. As the Hazardous Risk Mitigation Computer System 13 progresses the evolution of the simulation through this worst case scenario it stops at each critical stage of that evolution and the stakeholders responsible for performance at that stage are taken through the series of questions and situation assessments that are specified in the Stakeholder Performance Evaluation 44 for that stage of the incident and that elicit details of how the stakeholders would respond with actions at that time. This process continues until the entire scenario completes and all questions are answered, at which point the display of the Hazardous Risk Mitigation Computer System 13 appears similar to FIG. 19. Note that the consequences of the incident in terms of morbidities and mortalities are very high. This is because the abilities to prevent and respond to the scenario are intentionally set at the lowest levels where they quantify the worst case impact. This simulation under the worst case scenario is performed first in order to present all of the situations that may occur during the incident evolution. The responses to the questions posed during this process are captured and synthesized using the Mitigation Impact Profiles 34 into an evaluation of the Stakeholder Performance Ratings 52 demonstrated by the stakeholder(s) in each critical area. An example of the display of these data is shown in FIG. 20, which shows the name of the Mitigative Ability 120, and the Stakeholder Performance Evaluation 44 that was elicited from the previous run of simulation, expressed as a percentage value 122 but if the Mitigative Ability is not being exercised in the current simulation then it shows N/A (Not Applicable).

In the preferred embodiment the Hazardous Risk Mitigation Computer System 13 uses data of the performance levels exhibited by the stakeholders collected through the Mitigation Impact Profiles 34 to evaluate the timing and effectiveness of all key events and interventions that they would enact to affect incident evolution. The following describes one embodiment of this process. In this embodiment the high evaluation of Roles and Responsibilities (90%) and the high level of performance of Information Gathering and Warning (85%) exhibited by the Public Health Department would be synthesized by algorithms and methods in the Hazardous Risk Mitigation Computer System 13 to compute that the existence of some type of systemic incident would be identified when over 30 illnesses that appeared to be linked presented at a single location, and the incident would be detected by the Public Health Department within 3 hours after at that time. The simulation shows that 30 reports of illnesses occurred at a single location by hour 27 of the simulation (ten hours after the first presentation of illness at hour 17) so these algorithms would trigger the Incident Detection event at hour 30.

Further, the Hazardous Risk Mitigation Computer System 13 would evaluate that the high level of performance of Roles and Responsibilities (90%) combined with the high level of performance of Information Sharing (95%) exhibited by the sector-specific agencies would result in those agencies being alerted to the potential presence of the incident at hour 40.

The effects of the event of Incident Recognition by the Public Health Department would trigger that department to stand up an epidemiologic investigation into the causes of the illnesses. As a part of the epidemiologic investigation all patients that are potentially associated with an outbreak are contacted directly by the Public Health Department and questioned about the type of food that they have consumed over the last seven days. All of those reports are then triangulated to determine the list of foods that are possibly implicated in the contamination. The simulation of this massive, rapidly growing intoxication shows that within 24 hours of the incident detection the total number of illnesses increased to over 8,000. The high level of performance of the epidemiologic investigation ability demonstrated in the exercise (90%), together with this rapidly increasing number of related illnesses causes the Hazardous Risk Mitigation Computer System 13 to conclude that the epidemiology team would link the incident to a particular category of food product (e.g. produce, fish, etc.) within 24 hours of incident detection and to identify the specific food product (e.g. spinach, tuna, etc.) within 50 hours of incident detection. Consequently the Product Identification event is triggered at hour 80 (30+50).

The rapid increase in the number of illnesses and their multi-state location would cause the Hazardous Risk Mitigation Computer System 13 to make an assessment that the incident is multi-state incident (i.e. a group of adjacent states) with potential consequences at a very high level; consequently it triggers a Stop-Sale, Stop Movement order immediately following the Product Identification Event, at hour 80. This orders all companies that produce, distribute or market the type of product to stop all movement of the product for a specified period of time (typically 2-5 days); however no product is recalled or destroyed. The lack of specificity of product prevents the Hazardous Risk Mitigation Computer System 13 from triggering any broad scale public announcement at this time. The spatial awareness metric is a measure of the knowledge that the stakeholders have of the companies that are in the distribution chain of the contaminated product. The relatively low level of spatial awareness (50%) indicates that the stakeholders have prior identification and contact information on only 50% of the companies in the distribution chain for the suspected products. This will result in the identified 50% of the companies being contacted very quickly through that existing knowledge and so 50% of product movement is successfully stopped by the stop movement, but the lack of knowledge of the remaining 50% of the companies means that the remaining 50% of the product would continue to move through the distribution system normally until it is interdicted by a much slower process of manual investigation and identification of those companies.

The high level of performance of the Lab Testing ability (95%) and the Biological Agent Detection ability (75%) results in the contaminating agent being detected within 4 hours of Product Identification, which triggers the Agent Identification event at hour 84 and results in an announcement to the medical community of the incident involving the specific type of agent at hour 86.

The simulation shows that there is a very rapid increase in the number of illnesses in the period following the Product Identification event, which would result in the identification of the specific shipments of product that are contaminated that triggers a Shipment Identification event at hour 96, which due to the rapidly increasing number of mortalities triggers an immediate Public Announcement intervention, i.e. at hour 96. However the low level of stakeholder performance of the Public Information activity (55%) means that only 55% of the public will hear and react to the Public Announcement intervention in time to prevent their illness.

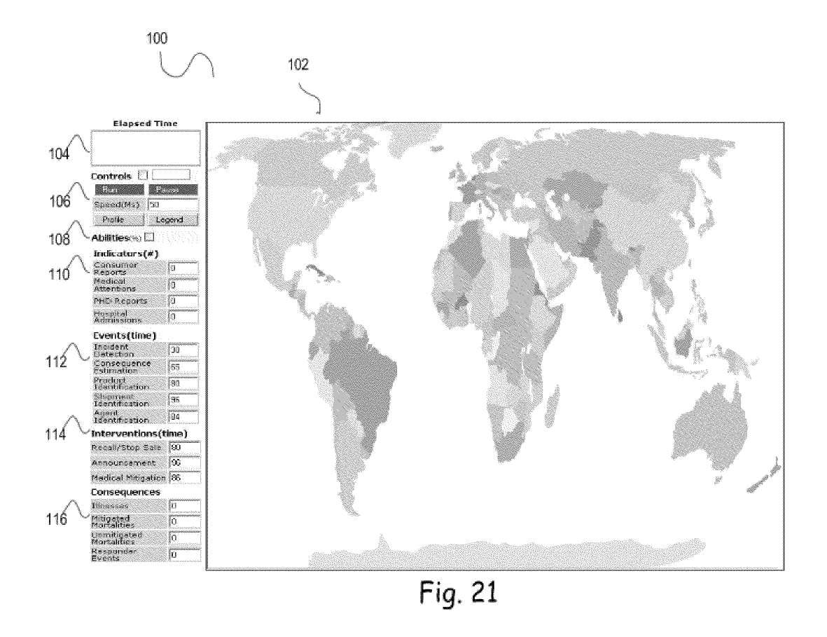

In the preferred embodiment, when the Hazardous Risk Mitigation Computer System 13 has computed the data described above a second simulation run is executed with these stakeholder values, to simulate the effects on the impact of the incident the stakeholder's level of performance. FIG. 21 shows the opening screen 100 for this second simulation run. The only difference from the opening screen in the initial (null) run is the presence of the data values in the Events Display area 112 and the Interventions Display Area 114 that represent the values established in the Hazardous Risk Mitigation Computer System 13 computations.

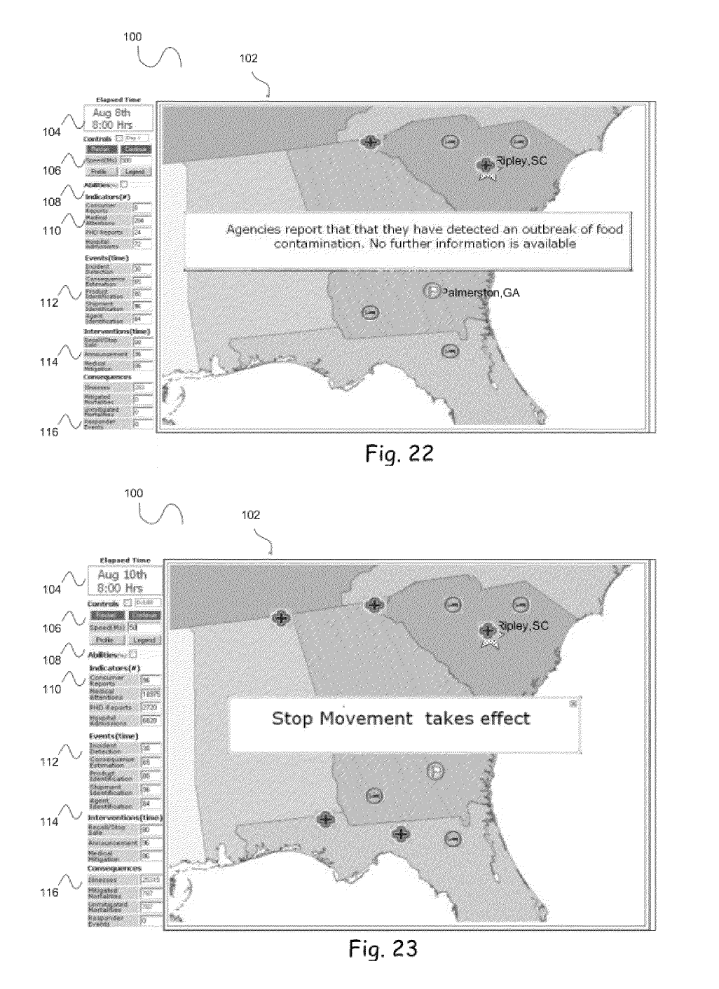

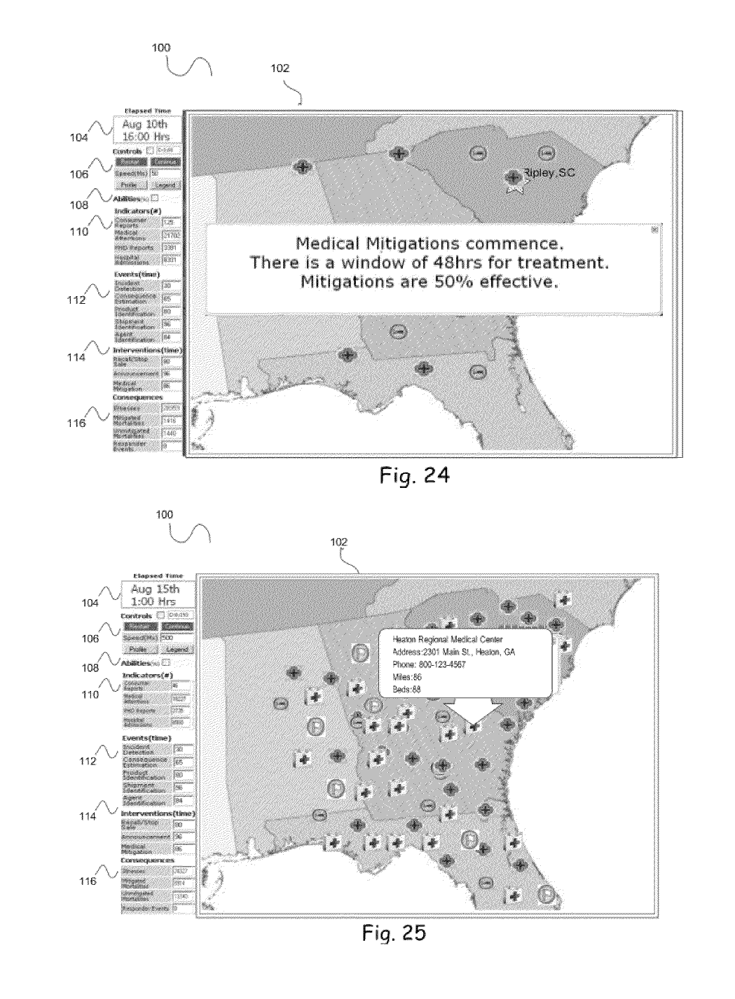

As this second scenario evolves it displays a banner that pops up to indicate the key events as they occur, for example FIG. 22 shows the banner that displays at hour 30 when the incident is detected. Similarly FIG. 23 shows the banner that displays at hour 80 when the Stop Sale/Stop Movement is invoked. FIG. 24 shows the banner that displays at hour 88 following the announcement being made to the medical community that medical mitigations of contaminated patience should commence, and the announcement also indicates the window for treatment following initial intoxication during which the medical mitigation will be effective and the percentage of patients whose symptoms are remediated by the medical mitigation.

At any time the facilitator can check the Controls Checkbox and the Scenario Controls area opens to show several additional buttons. In FIG. 25 the “Hospitals” button 134 has been clicked showing a collection of icons in the form of a small suitcase with a cross in the center. Each of these icons represents the location of a hospital. Successive clicks of the “Hospitals” button 134 cause the icons to appear in an increasingly large radius around the center of the GIS Map 102. In the FIG. 25 the button has been clicked several times to show the hospitals in a radius of 150 miles from the center of the GIS Map 102. Also in FIG. 25 one of the icons has been clicked to show the Hospital Data display 136.

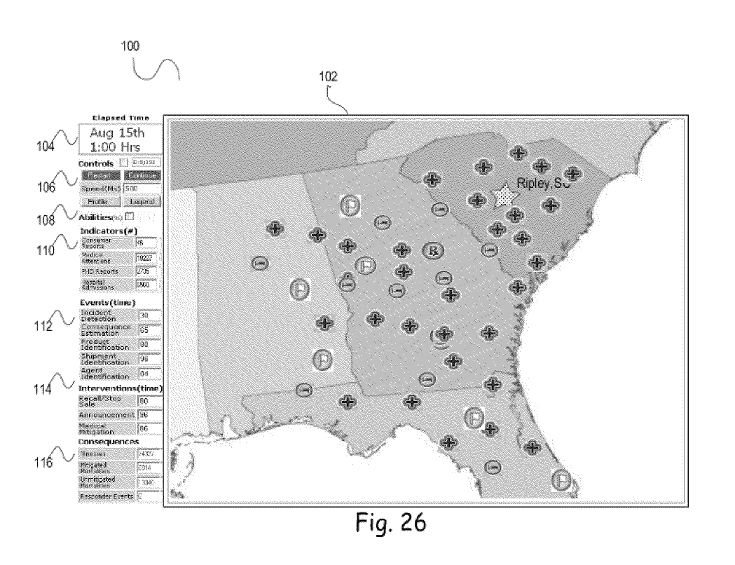

This simulation continues to completion at which time the impact of the incident can be seen as illustrated in FIG. 26.

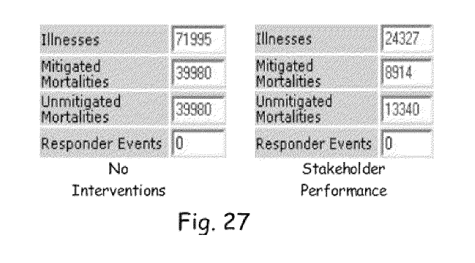

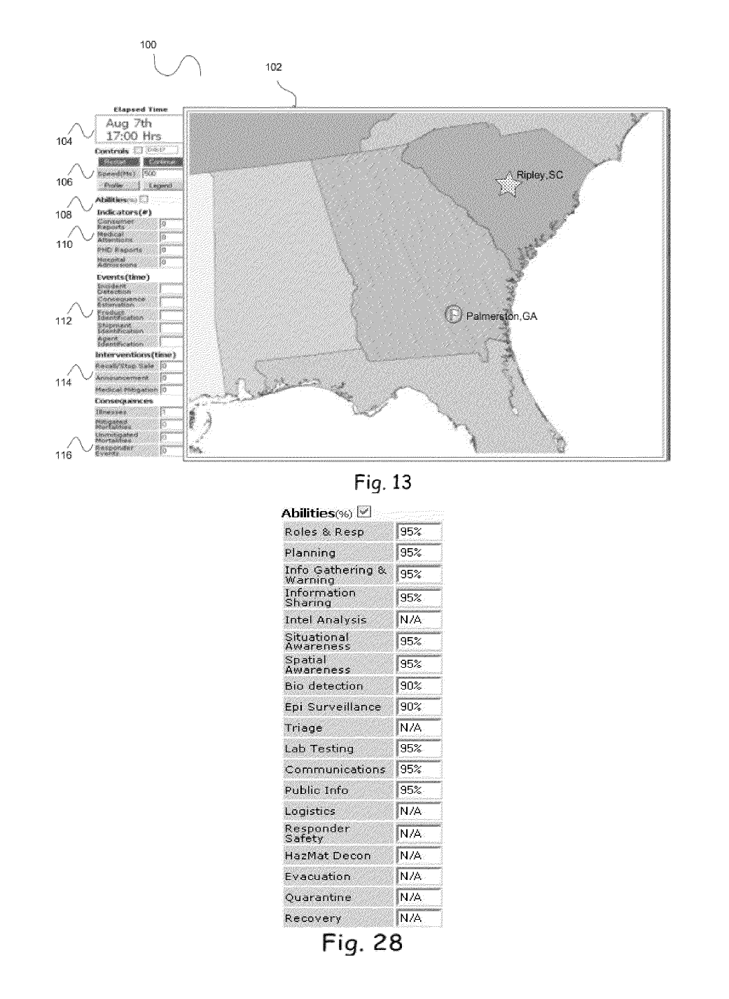

The results of the two runs are illustrated in FIG. 27 which shows the Impacts Display area 116 as it was displayed at the completion of the first (worst case) run on the left, and the Impacts Display area 116 as it was displayed at the completion of the second (stakeholder values) run on the right. As can be seen, the stakeholder response reduces the illnesses that result from the incident by over 66% (from 71995 to 24327) and the unmitigated mortalities that result from the incident by approximately 66% (from 39980 to 13340); and with the added effects of medical mitigation this reduced the level of mortality by over 77% (from 39980 to 8914. There were no Responder Events (casualties of first responders) in either case.

While these improvements are highly effective, the reason that this scenario was selected for stakeholders to improve their abilities to mitigate the scenario is because their existing performance levels were below the Mitigation Performance Targets 46 that were set as the optimum levels of performance for the Key Mitigative Abilities 30 of the scenario. These Mitigation Performance Targets 46 are illustrated in FIG. 28.

To demonstrate the improved results that could be achieved if the stakeholders improved their abilities to those target levels, following the completion of running the Hazardous Risk Mitigation Computer System 13 under the current stakeholder performance levels a third run of the Hazardous Risk Mitigation Computer System 13 is performed using the values of Mitigation Performance Targets 46 shown in FIG. 28.

In the preferred embodiment of the Hazardous Risk Mitigation Computer System 13 these data on the level of performance exhibited by the stakeholders collected through the Mitigation Impact Profiles 34 would evaluate that the target levels of Roles and Responsibilities (95%) and of Information Gathering and Warning (95%) would indicate that the existence of some type of systemic incident would be identified when over 20 illnesses that appeared to be linked presented at a single location and that the incident would be detected by the Public Health Department within 1 hour after at that time. The simulation showed that 20 reports of illnesses presented at a single location by hour 21 of the simulation, so these algorithms would trigger the Incident Detection by the Public Health Department at hour 22, the high level of target performance of Roles and Responsibilities (95%) combined with the high level of performance of Information Sharing (95%) would result in the sector-specific agencies being alerted to the existence of the incident at hour 26 and the Public Health Department would immediately trigger that department to stand up an epidemiologic investigation into the possible causes of the illnesses.

The high level of target performance of the epidemiologic investigation ability (95%), together with this rapidly increasing number of related illnesses causes the Hazardous Risk Mitigation Computer System 13 to conclude that the epidemiology team would link the incident to a particular category of food product within 18 hours of the start of the investigation and to identify the specific food product (e.g. spinach, tuna, etc.) within 24 hours of the start of the investigation. Consequently the Product Identification event is triggered at hour 50 (26+24). The rapid increase in the number of illnesses would cause the Hazardous Risk Mitigation Computer System 13 to trigger a Stop-Sale, Stop Movement order immediately following the Product Identification Event, at hour 50.

The high level of spatial awareness (95%) indicates that 95% of the product movement would be successfully stopped due to the depth of knowledge of the stakeholders of the identification and contact information of the companies in the distribution chain for the suspected products. The remaining 5% of the product would continue to move through the distribution system normally until it is interdicted by the much slower process of manual investigation and identification of those companies.

The high level of performance of the Laboratory Testing ability (95%) and the Biological Agent Detection ability (95%) results in the contaminating agent being detected within 4 hours of Product Identification, which triggers the Agent Identification event at hour 54 and results in an announcement to the medical community of the incident involving the specific type of agent at hour 55. The rapidly increasing accumulation of illnesses would result in the identification of the specific shipments of product that are contaminated within 12 hours of product identification, which would trigger a Shipment Identification event at hour 62, which due to an increasing number of mortalities would trigger an immediate Public Announcement intervention, i.e. at hour 62. The high level of the target Public Information activity (95%) means that 95% of the public will hear and react to the Public Announcement intervention in time to prevent their illness.

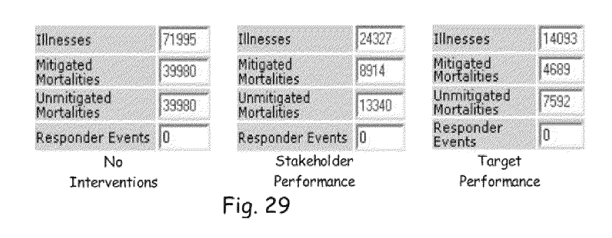

These data are used to execute the third simulation run of the system, the results of these three runs are illustrated in FIG. 29 which shows the Impacts Display area 116 as it was displayed at the completion of the first run (with no interventions) on the left, as it was displayed at the completion of the second (stakeholder performance) run in the center, and it was displayed at the completion of the third (Target Performance) run on the right. As can be seen, if the stakeholders could improve the performance of their Key Mitigative Abilities 30 to the target values this would reduce the illnesses that result from the incident by over 80% (from 71995 to 14093), the unmitigated mortalities that result from the incident by approximately 81% (from 39980 to 7592); and the mitigated mortalities by over 88% (from 31980 to 4689), which would be an improvement over their existing levels of the number of illnesses by 42% (from 24327 to 14093), the unmitigated mortalities by over 43% (from 13340 to 7592); and the mitigated mortalities by over 47% (from 8914 to 4689). In no case were there Responder Events (casualties of first responders).

Following the exercise the Mitigation Computer System 13 is used to perform the Risk Mitigation process 24 that synthesizes the results of the exercises into a recommendation for the specific activities to be performed in the Risk Mitigation program and compiles all results into the Risk Management Plan 20. In a second training session subsequent to the exercise, the stakeholders are provided a copy of the Risk Management Plan 20 and the responsibilities for implementing the Mitigation Plans 54 are discussed and time-frames and resource requirements determined. The stakeholders are then responsible for implementing the remedial Mitigation Plans. If the stakeholders participating in the implementation of the system 10 are governmental agencies/organizations then following the completion of the exercise the results of process are compiled into a “Homeland Security Exercise Evaluation Program” (“HSEEP”) compliant After Action Report, which is a report that is essential in justifying applications for federal grants to fund the remediation activities.

Following completion of the remedial actions undertaken by the stakeholders in response to the initial the system 10 implementation the entire process is evaluated by the Mitigation Effectiveness process 22 to determine the effectiveness of the remedial actions in remediating areas of deficiency and to indicate additional areas for continuation of that improvement. Where different stakeholders have undertaken different remediation approaches, the relative success of these different approaches are compared and the practices that generated the best results are documented and entered into the Data base 16 as recommended Best Practices 50 for remediation activities.

The datasets developed in the use of the system 10 not only facilitate identifying the levels of ability of a stakeholder in the subject area, but also provide a “roadmap” that can be used during an incident to determine the mission critical assignments that should be completed at each stage of such an incident and the optimal ways of performing such assignments.

Following the completion of the implementations of the system 10 to an appropriate level where the datasets are determined to be valid for deployment during a live incident, the Risk Mitigation process 24 provides functionality that enables any stakeholder to enter into the Hazardous Risk Mitigation Computer System 13 the current knowledge surrounding any live incident and updates to the completion status of any assignment that has been undertaken for its mitigation. The Hazardous Risk Mitigation Computer System 13 in response provides a list of the pre-scripted essential tasks that should have been completed prior to that stage of evolution of the incident, a list of the new assignments that should be commenced at that stage, and an updated schedule for assignments that must be completed, and prints out field operations guides for each stakeholder that detail the status of each of the pre-scripted tasks that should have been completed or should be initiated by that stakeholder during the subject time period.

What is claimed is:

1. A hazardous risk mitigation system, methods and computer programs that enable any stakeholder that has responsibility for responding to hazardous incidents with a systematic process whereby they can optimize their ability to execute responses that will reduce the harm caused by such incidents.

2. The method of claim 1, wherein the nature of the hazardous incident is a terrorist incident, an unintentional or intentional contamination of a consumable product, a natural disaster, an accidental incident or other current or historical event.

3. The method of claim 1, whereby the plurality of hazard scenarios is enumerated and high priority hazards are identified.

4. The method of claim 1, wherein the plurality of Key Impact Metrics used to evaluate the harm caused by the incident are identified and enumerated.

5. The method of claim 1, whereby high priority hazard scenarios are selected by simulating each such scenario, quantifying the values of the Key Impact Metrics for each scenario, and prioritizing the scenarios that exhibit the greatest adverse values of such metrics.

6. The method of claim 1, whereby a comprehensive plan to optimally manage and reduce the risk presented by the high priority scenarios is created and implemented for each responding stakeholder.

7. The method of claim 6, comprising the steps of:
enumerating the plurality of Key Response Abilities, being those abilities required to respond to the incident,
correlating each of those Key Response Abilities to the Key Impact Metrics that it affects,
quantifying the ability of a stakeholder to invoke interventions into the evolution of an incident.
quantifying the correlation between changes in the quantification of a Key Mitigative Ability and consequent changes in the quantification of Key Impact Metrics.

8. The method of claim 6, whereby target levels of each Key Mitigative Ability are determined for selected hazard scenarios.

9. The method of claim 6, whereby the activities, resources and investments required for effective response to the priority incidents are identified and prioritized.

10. The method of claim 6, whereby the current levels of each Key Mitigative Ability are determined for selected hazard scenarios.

11. The method of claim 10 whereby the current levels of each Key Mitigative Ability are determined by simulating each selected scenario and evaluating the effect of the activities of that simulation.

12. The method of claim 11, whereby said simulation is implemented by a computer program and the exercise is enacted using that computer program.

13. A method of claim 11, whereby such simulation is depicted using a graphical user interface in the form of an animated, computerized map with displays of the physical and human resources required for effective response.

14. The method of claim 11, whereby said simulation is implemented by a live enactment using live responders.

15. The method of claim 6, whereby the ability of stakeholders to invoke interventions into the evolution of an incident are computed from current levels of each Key Mitigative Ability.

16. The method of claim 6, whereby the abilities to be remediated are prioritized by the degree to which investments in such remediation yield the greatest aggregate reduction of adverse effects due to the selected hazard scenarios.

17. The method of claim 6, whereby the training required to successfully implement the risk management plan is evaluated and implemented.

18. The method of claim 16 whereby key personnel responsible for response are trained using a computerized software program.

19. The method of claim 16 whereby said training is performed by participating in training exercises.

20. The method of claim 6, whereby the risk management plans and activities of ability remediation are continuously reviewed and updated.
